(19) United States
(12) Patent Application Publication
(10) Pub. No.: US 2015/0363711 A1
(43) Pub. Date: Dec. 17, 2015

(54) DEVICE FOR RAPID OPERATIONAL VISIBILITY AND ANALYTICS AUTOMATION

(71) Applicant: Flutura Business Solutions Private Limited, Bangalore (IN)

(72) Inventors: Krishnan Raman, Bangalore (IN); Srikanth Muralidhar, Bangalore (IN); Derick Jose Jude Thaiparambil, Bangalore (IN); Ganesh Parthasarathy, Bangalore (IN); Bharath Ramanathapur Srinivasan, Bangalore (IN); Renoo John Chandy, Bangalore (IN); Santosh Sahoo, Bangalore (IN)

(73) Assignee: FLUTURA BUSINESS SOLUTIONS PRIVATE LIMITED, Bangalore (IN)

(21) Appl. No.: 14/536,101

(22) Filed: Nov. 7, 2014

(30) Foreign Application Priority Data
Jun. 11, 2014 (IN) 2843/CHE/2014

(51) Int. Cl. G06Q 10/06; G06F 17/30; G06Q 10/10

(52) U.S. Cl. CPC G06Q 10/063; G06Q 10/067; G06Q 10/10; G06F 17/30592

(57) ABSTRACT

A portable device for automating data analytics includes a configurator module, wherein the configurator module when plugged into a client device enables a user of the client device to configure a plurality of parameters. The portable device further includes a Rapid Operational Visibility (ROVi) engine for automating data analysis. The ROVi engine performs automating data capture from a plurality of data sources based on configured parameters. Further, the ROVi engine creates a data model automatically. The ROVi engine automates creation of interfaces, automates generation of a semantic layer, and enables the user to create customized analytical reports.

### CROSS-REFERENCE TO RELATED APPLICATION

This application claims the priority of Indian Provisional Patent Application No. 2843/CHE/2014 filed on Jun. 11, 2014, the disclosure of which is incorporated herein in its entirety.

### FIELD OF THE INVENTION

The present invention relates to a device for end-to-end automation of business intelligence (BI) system development, and more specifically to a system for automation of end-to-end data analytics, including data capture, data analysis, and analytical insight generation.

### BACKGROUND

Data warehouses are informational databases used to store operational, analytic and transactional data from one or more databases. Data warehouses include data from different databases aligned to a specific data model and relating to one or more business enterprises. People use data warehouses and associated reporting tools to track and respond to business trends and cultivate business intelligence (BI). OLAP is one approach used in gearing up BI applications.

Online analytic processing (OLAP) system is a type of information system that facilitates quick analysis of data in a data warehouse to generate business reports. Examples of business reports include, but are not limited to sales report, marketing report, and business operations management report. An Online transaction processing (OLTP) system facilitates the automation of core business processes and provides the OLAP system data from various data sources for analytics. While OLTP system may be viewed as a collector of raw data, the OLAP system will be viewed as a user of the data for generation of business insights. The OLAP system queries are often complex and involve aggregations of the data stored in one or more OLTP databases and OLAP databases typically stores aggregated, historical data.

Existing data processing systems use both OLTP system and OLAP system together, where the OLTP system handles rapid transaction processing and the OLAP system handles rapid querying and report generation. The data generated during the business operations can be structured, semi-structured or unstructured. The transactional data from various OLTP systems are extracted, transformed into desired format and loaded into the OLAP system. In conventional systems where the OLAP system and OLTP system are operated as separate systems, data capture and report generation is a tedious and time-consuming procedure.

In one existing system, a data processing system includes raw data storage, metadata storage, and an interest-driven data pipeline to generate reporting data using the raw data. The interest-driven data pipeline is compiled based upon reporting data requirements automatically derived from at least one report specification defined using the metadata. However, the existing approach to develop the interest-driven data pipeline has several limitations. The schema of data in the data warehouse has to be generated manually by a user. Further, the architecture only supports one business model. Furthermore, interfaces to other databases have to be coded manually.

Data processing systems can be used for developing BI applications. Typically, project life cycle of a Business intelligence (BI) application includes defining business requirements, developing, testing and reporting. FIG. 1 illustrates a flowchart depicting the traditional BI project lifecycle. The key steps in a BI project cycle includes defining requirements by a user, followed by gathering data, storing data, analyzing data and providing access to processed data. The project life cycle includes a design stage performing data modeling, wherein a normalized data model is designed after defining facts and dimensions of data. Facts are typically numeric values that can be aggregated, and dimensions are groups of hierarchies and descriptors that define the facts. The development stage in the BI project includes Extract Transform Load (ETL) design and development. ETL stage extracts data from multiple data sources based on defined requirements, transforms collected data to required format, and load the transformed data into a data warehouse. After the data modeling and ETL processes, a data mart is available to the end user for reporting and analysis. Sample data is provided to generate reports and facilitate User Acceptance Testing (UAT). The BI application is checked for user's expectations in UAT. Further, reports are generated for user analysis. The traditional method is time consuming and tedious. Moreover, the coding for each stage from requirements definition to report generation has to done manually by the developer, and the entire project cycle consumes typically about 6 months.

The overall process being so complicated and error prone, there is an impending need for a device and a system to automate the processes in BI system development. Further, there is a dire need to simplify integration to capture data from external sources without the need for laborious coding. Furthermore, it is desired to address the data gaps present by having a device with flexibility in creating user interface screens that can capture data on Key Performance Indicators (KPI)'s. Often, it is desired to reduce the time consumed in development of typical BI systems and it is highly desired to have a device and a system that automatically generate BI applications by dynamically integrating with existing OLTP and OLAP systems.

In light of the foregoing discussion, there is a need for an efficient device for data analytics which automates the process from data capture to report generation. Moreover, there is a need for a system which is rapid, time efficient, provides flexibility for interfacing data from various sources, and captures data through a user interface where there is lack of data availability; a system where user doesn't have to manually create interface layers, reporting layers and management data layers.

### SUMMARY

The above mentioned needs are met by an automated system for data analytics and rapid operational visibility. The system automates the whole processes from data integration to data capture to semantic layer generation as well as provides users with customizable interface for report generation.

Cerebra ROVi™ is an example of a portable device for automating data analytics and the portable device includes a configurator module, wherein the ROVi Configurator module when plugged into to a client device network enables a user to configure a plurality of parameters. The portable device further includes a ROVi Engine that algorithmically creates a data model to enable data analysis. The ROVi engine also automates data capture from a plurality of data sources based on configured parameters. Further, the ROVi engine automates creation of interfaces, generation of a semantic layer, and enables the user to create customized analytical reports.

Cerebra ROVi™ is an example of a system for automating data analysis and the system includes a configurator module for enabling a user to configure parameters, wherein the parameters comprises at least one of business rules, user interface (UI) screens, interface to external data sources, and definition of key performance indicators. The system includes a Rapid Operational Visibility (ROVi) engine for automated data analysis. The ROVi engine includes a data modeller for performing one of capturing data automatically based on configured parameters and creating an optimized data model for reporting. The ROVi engine includes a master data management (MDM) generator to ensure quality of data, a user interface (UI) generator for automating generation of UI screens, an interface generator to automatically integrate data from external sources, and a semantic layer generator for multi-dimensional data analysis and creation of custom reports.

Cerebra ROVi™ is an example of a computer-implemented architecture for automating data analysis includes a processor coupled to, at least one storage system, at least one input device, and at least one output device to receive data and instructions. The processor is programmable to operate a configurator. The configurator module enables a user to configure parameters, wherein the parameters comprises at least one of business rules, user interface (UI) screens, interface to external data sources, and definition of key performance indicators. The processor is programmed to operate a Rapid Operational Visibility (ROVi) engine for automated data capture and data analysis. The ROVi engine includes a data modeller for performing one of capturing data automatically based on configured parameters and creating an optimized data model for reporting. The ROVi engine includes a master data management (MDM) generator to ensure quality of data, a user interface (UI) generator for automating generation of UI screens, an interface generator to automatically integrate data from external sources, and a semantic layer generator for multi-dimensional data analysis and creation of custom reports.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF FIGURES

In the following drawings like reference numbers are used to refer to like elements. Although the following figures depict various examples of the invention, the invention is not limited to the examples depicted in the figures.

FIG. 1 is a flowchart illustrating a traditional business intelligence project life cycle in accordance with a prior art;

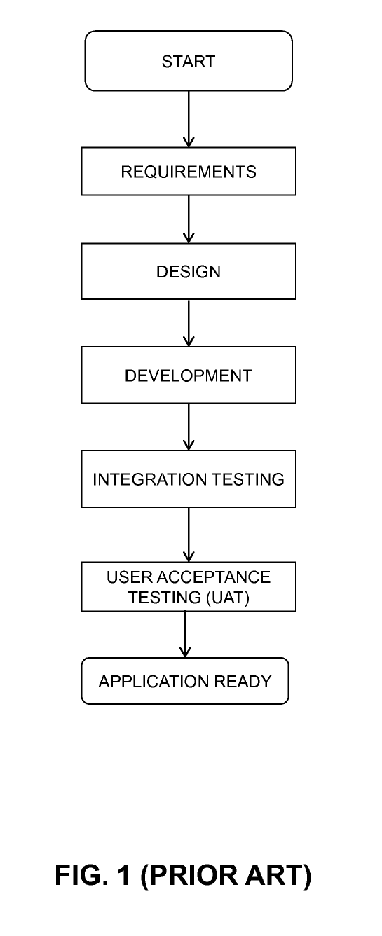

FIG. 2 is a block diagram of an environment, in accordance with one embodiment of the present invention;

FIG. 3 is a flowchart illustrating various processes performed by a data analytics device;

FIG. 4 is a block diagram of a system for data analytics in accordance with another embodiment of the present invention; and

FIG. 5 is a flowchart illustrating steps involved in automating the process in a BI system development, in accordance with one embodiment of the present invention.

### DETAILED DESCRIPTION

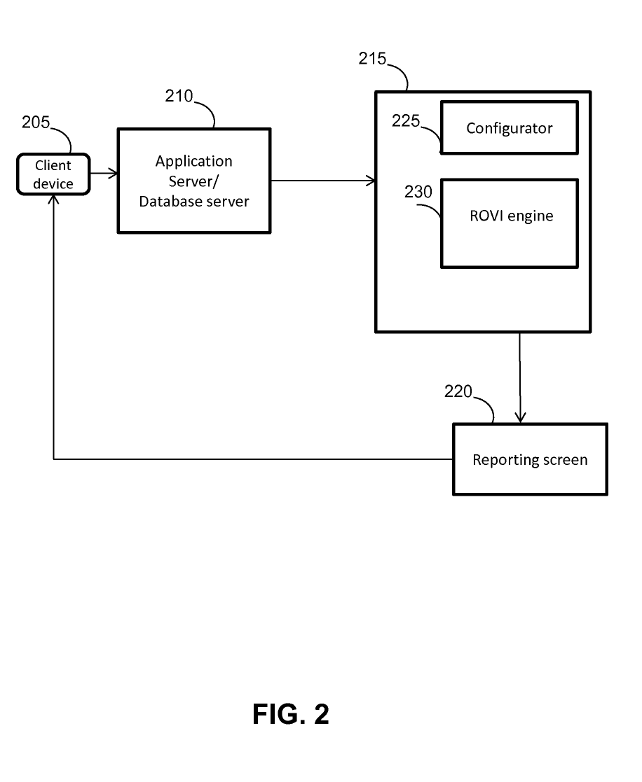

A device and a system to automatically generate business intelligence (BI) applications are explained in detail in conjunction with FIGS. 2-5. Embodiments of the present disclosure described herein provide a device and system for automating the process from data capture to report generation using a CEREBRA ROVi™ inflator. ROVi stands for Rapid Operational Visibility. CEREBRA ROVi™ inflator is a architecture for automating data analysis in various data analytic systems. The CEREBRA ROVi™ inflator can be seamlessly integrated with existing OLAP and OLTP systems for developing BI applications.

FIG. 2 is a block diagram of an environment, in accordance with one embodiment of the present invention. The environment includes a client device 205 accessing an application through a browser. The application is stored in an application server 210. The application server 210 provides a plurality of applications stored in a database. Some examples of applications are Tally® and SAP ERP®. The scope of the present invention includes a portable data analytics device 215 that captures data automatically from one or more applications from the application server 210 for automated creation of business intelligence (BI) applications for further data analysis.

The two key components of the portable data analytics device 215 are a configurator module 225 and a ROVi engine 230. The configurator module 225 enables users to configure parameters in the application through a user interface (UI) screen. The parameters include at least one of a plurality of entities, business rules, user interface (UI) screens, interface to external data sources and definition of key performance indicators. The ROVi engine 230 assigns relationships between the pluralities of entities. Further, the ROVi engine 230 creates the UI screens for a particular entity in the application. The data is captured from the UI screens and other external sources. A data model is built based on the parameters, and the data captured is bound to the data model. Furthermore, the ROVi engine 230 implements the business rules on the captured data. The ROVi engine 230 is designed to enable a user to create new measures and custom calculations for the captured data. Further, the ROVi engine 230 creates an optimized data model for reporting. The semantic layer is generated automatically based on the optimized data model. The semantic layer is used for reporting and further enables the user to customize reports. The reports are displayed on a reporting screen 220 within the client device 205. The reporting screen 220 can be customized as per user requirements.

It is to be noted that the portable data analytics device 215 can be carried to customer premises and configured based on customer's requirements. In one embodiment of the present invention, the portable data analytics device portable data analytics device 215 can be implemented in a server. The server can be attached to the client device for data analytics and report generation. In another embodiment of the present invention, the data analytics can be performed by implementing the system in a cloud environment.

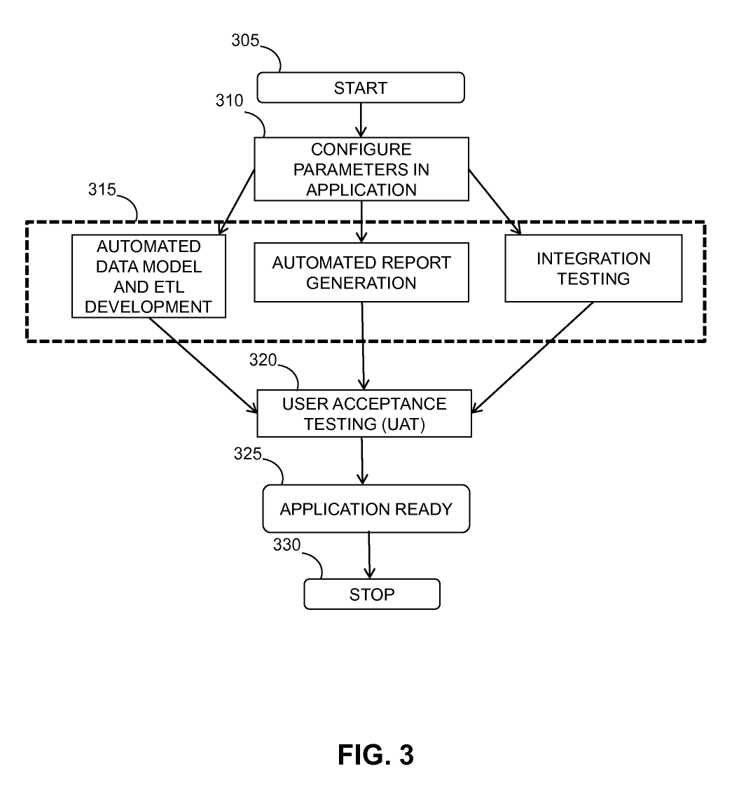

FIG. 3 is a flowchart illustrating the various processes performed by a portable automated data analytics device. The process begins at step 305.

At step 310, the portable data analytics device is electrically connected to a client device and the client device enables a user of the client device to configure a plurality of parameters in a Business Intelligence (BI) application. The plurality of parameters include at least one of a plurality of entities, business rules, user interface (UI) screens, interface to external sources, and definition of key performance indicators.

At step 315, a ROVi engine automates the processes such as data capture, data modelling, and report generation. Some examples of data sources are financial and accounting tools like Tally®, enterprise resource and planning tools like SAP® ERP software, or Microsoft® ERP software, banking software, sales and marketing ERP tools, and customer relationship management. Data capture includes an Extract, transform, and load process (ETL). The data is captured automatically from a plurality of data bases and interfaces. An Interface generator creates a layer which will allow the ROVi engine to connect to other systems and pull in data from other source systems. The ROVi engine creates a data model integrating data from external sources and further creates a Master Data Management (MDM) layer automatically. Furthermore, the ROVi engine generates reports automatically based on the user defined configurations. In integration testing stage, the system is checked for faults while interacting with various units and processes.

At step 320, User acceptance testing (UAT) is performed to check the acceptance of the BI application based on sample data provided. The reports generated automatically are viewed by the user for analysis and further modifications.

At step 325, the portable data analytics device makes the Business Intelligence application ready for review by the user. Examples of BI application include Banking reports and sales inventory.

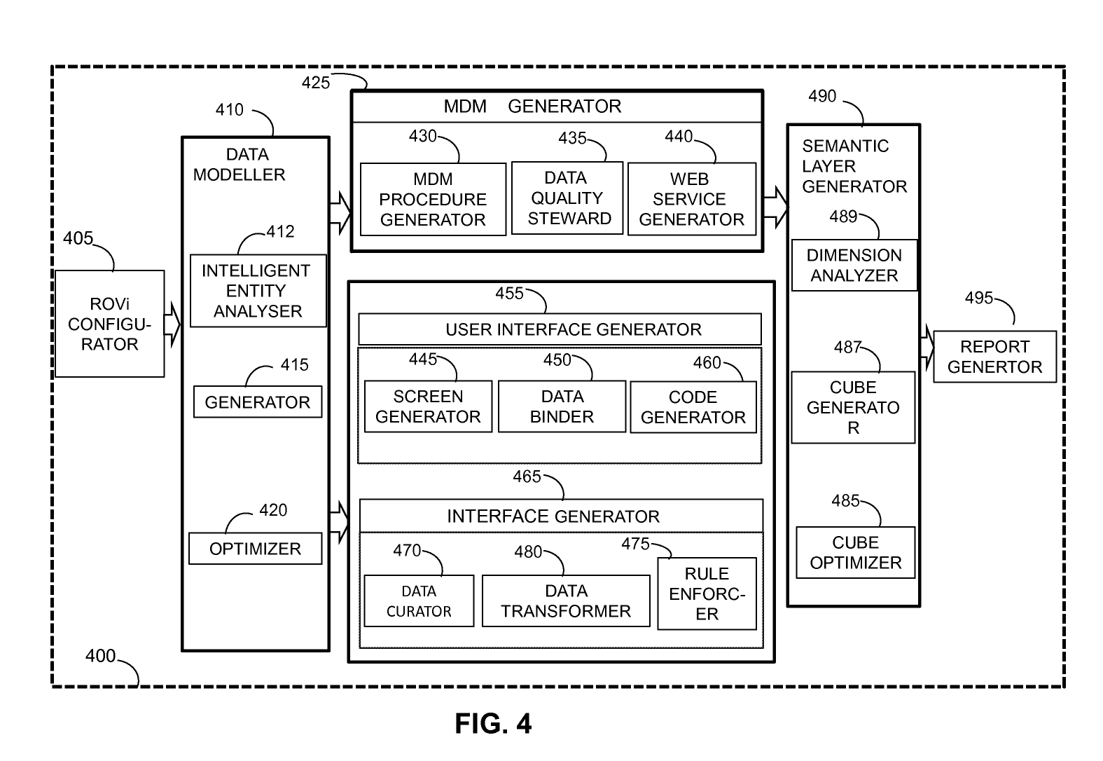

FIG. 4 is a block diagram of a system for data analytics in accordance with another embodiment. The diagram discloses a portable data analytics device 400. The device 400 includes a ROVi Configurator 405 and a CEREBRA ROVi OLTAP inflator, hereinafter referred to as a ROVi engine. The major components in the device 400 include a Data Modeller 410, an Interface Generator 465, a User Interface (UI) 455, a Master Data Management (MDM) Generator 425, and a Semantic Layer Generator 490. The ROVi Configurator 405 is referred to as Configurator module.

In a typical Online Transaction Processing (OLTP) model, during a transaction operation, user interface (UI) screens are generated. Various entities of transactions are mapped to attributes related to the entity. In an example, a user feeds sales as the entity through the UI screens. A number of attributes like customer name, product, location and time are mapped to the entity when the information is provided by the user. In the present invention, the user configures the various entities required for reporting in the ROVi Configurator 405. The user enters the entities and the attributes related to each entity in the ROVi Configurator 405. Further, the user can choose to have at least one of a data screen and an interface. The user chooses parent-child relationship between the various entities. Furthermore, the user defines business rules for each entity. Examples of business rules include, name column should not be null, and the length of the code should not be greater than 10 characters etc. The business rules perform an operation for each modification of data within a database. Further, the ROVi configurator 405 codes the information provided by the user. The data from various OLTP systems are extracted based on the configuration. Further the data is provided to the Data Modeller 410. The capturing of data by the data modeller 410 is a multi-level data capture process.

The data modeller 410 captures data automatically based on configured parameters. Further, the data modeller 410 creates an optimized data model for reporting. The data Modeller 410 reads metadata information provided by the Intelligent Entity Analyser 412. The Intelligent Entity Analyser 412 creates groups of master data and fact tables based on the relationships provided in the ROVi configurator 405. Once the groupings are completed, generator 415 generate SQL scripts using the configuration metadata which further creates tables, relationships, primary key, foreign key and indexing for the tables. Output of the generator 415 is a snowflake schema.

Following the creation of the snowflake schema, an optimizer 420 reads metadata provided in the ROVi configurator 405 and verify the relationships between different entities. If there is a dimension which is in a normalized form, then the Optimizer 420 creates a D Level table where in all the entities in hierarchy are brought into one single table. The procedure includes finding list of related tables, and obtaining the list of all attributes for the tables. Further, the procedure includes adding columns to store the parent name, parent ID and level name along with audit columns into the SQL script for a new table. If the table already exists, then the optimizer 420 proceeds by altering the existing table adding new columns.

The Master Data Management (MDM) generator 425 present in the ROVi engine ensures quality of data captured. Master Data Management (MDM) generator 425 creates a master data management layer automatically. The master data management layer acts like a single point of reference. The MDM layer enables users to configure custom Key Performance Indicators (KPI). The master data management generator 425 includes a MDM procedure generator 430, a data quality steward 435, and a web service generator 440. The MDM procedure generator 430 generates procedures for allowing a master data to be created, updated, and disabled. The data quality steward 435 also referred as data quality monitoring module enforces data quality. The data quality steward 435 performs auto correction of data based on the trust factor of data source from which data is being pulled into the system. For example, if there are two data sources ‘A’ and ‘B’, wherein the data source ‘A’ providing data as “Puma™”, and data source ‘B’ providing data as “Pma”, then the data quality steward 435 updates and corrects the data from source ‘B’ as “Puma” after verification. The web service generator 440 creates web services for the master data created in the ROVi engine. Other applications wanting to use the master data can extract data from the ROVi engine through the web service.

The User Interface (UI) generator 455 includes a screen generator 445, a data binder 450, and a code generator 460. The screen generator 445 generates UI screens for entering various entities. The data binder 450 provides a common metadata model and a common data model into which the various data sources are mapped. The data binder 450 collects data from external sources through interfaces. The code generator 460 provides Create, Update and Delete operations for the workflow. Further, the code generator 460 creates codes for user management depending on the mode of configuration.

The Interface Generator 465 captures data from various external sources and binds to a data model. The Interface Generator 465 includes a data curator 470, a rule enforcer 475 and a data transformer 480. The data curator 470 collects and aggregates data from various external sources. The rule enforcer 475 applies various business rules configured by the user. The business rule operations run a script, and make changes in database when one of a display, insert, update, delete, and query operation is performed on a database. The aggregated data is dumped into a staging area and the data transformer 480 transforms the data in a suitable format for storage in ROVi's data repository after applying business rules.

The Semantic Layer Generator 490 generates a semantic layer for multi-dimensional data analysis and creation of custom reports. The semantic layer enables users to plug into the semantic layer to perform adhoc reporting and creation of custom reports.

The Semantic Layer Generator 490 creates a layer optimized for reporting. The user can create new calculated measures and custom base measures for an online analytical processing (OLAP) cube, hereafter known as cube. The cube is a multidimensional database that is optimized for data warehouse and OLAP applications. The measures are the set of values in a cube based on dimensions in the cube's fact table. Fact tables describe events in a business process, for example purchases and returns. Examples of dimensions include but not limited to people, products, and other such objects. Typically, the measures are numeric values. In other words, the measures are the central values in the cube that are pre-processed, aggregated, and analyzed. Examples of the measures include sales, profits, revenues, and costs. In the cubes, data and measures are categorized by dimensions. Cubes are often pre-summarized across dimensions to drastically improve query time over relational databases Thus, the semantic layer is generated based on the optimized data model. In the present invention, the semantic layer enables the user to customise reports. The user can create custom reports using the semantic layer.

The Semantic Layer Generator 490 includes a dimension analyser 489, a cube generator 487 and a cube optimizer 485. The dimension analyser 489 creates dimensions and hierarchies automatically. Fact tables with the same primary keys (i.e. the same dimensions) are combined. The related dimensions should be consolidated together into a single dimension table. The cube generator 487 generates arrays of data called cubes based on the dimensions and measures. The cube optimizer 485 creates aggregation rules and partitions in analytical layer to ensure a good quality report. The report is presented in a reporting layer interface automatically created by a report generator 495. Therefore, the process of data capture, Master Data Management layer creation, Interface generation, User interfaces and Reporting layer interfaces are automatically generated based on the reporting requirements.

The portable data analytics device 400 can be carried to customer premises and configured based on customer's requirements. In one embodiment of the present invention, the portable data analytics device 400 can be implemented in a server. The server can be attached to the client device for data analytics and report generation. In another embodiment of the present invention, the data analytics can be performed by implementing the system in a cloud environment.

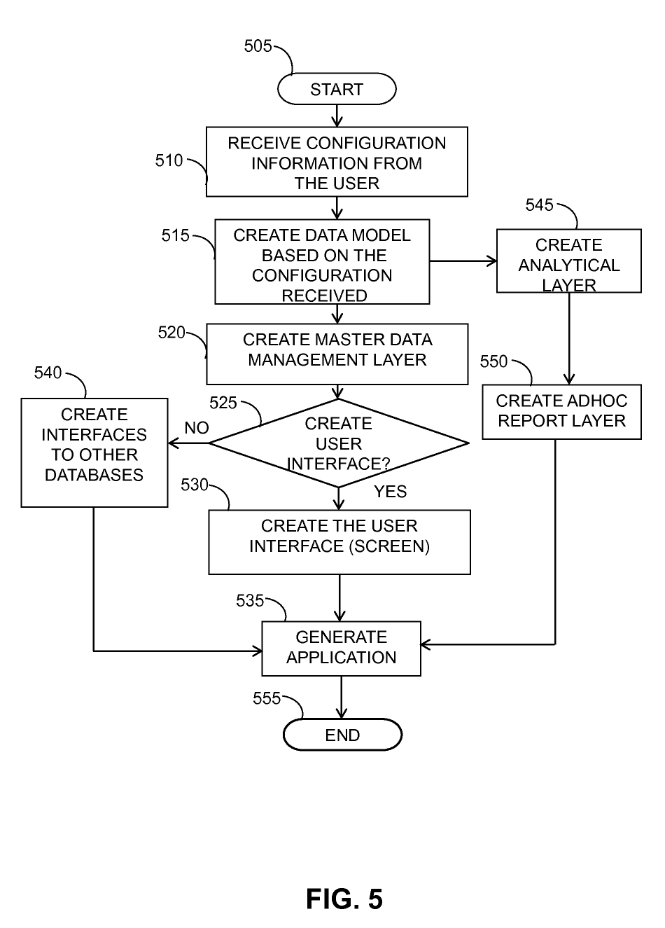

FIG. 5 is a flowchart illustrating the steps involved in automating the process from data capture to report generation in a BI system development. The flowchart begins at step 505.

At step 510, configuration information relating to the various entities is received from a user. The user enters the respective attributes along with business rules.

At step 515, a data model is created automatically based on the received configuration.

At step 520, a master data management layer is created automatically by a ROVi engine to create master data. The ROVi engine creates codes to manage master data thereby ensuring quality of data.

At step 525, the ROVi engine determines whether to create user interfaces for entering various entities. If user interface is required step 530 is performed, else step 540 is performed.

At step 530, the ROVi engine creates user interface for entering the details corresponding to various entities and respective attributes. The data is collected from various external sources through the user interfaces. The data is further bound to a common data model.

At step 540, an interface layer is created that links to other databases. The Interface layer provides flexibility between various databases and extracts data without any specific schema.

At step 545, an analytical layer is automatically created by the ROVi engine based on step 515. The user can create custom Key Performance Indicators (KPI) in the analytical layer, wherein the users can create new calculated measures and custom measures.

At step 550, an adhoc reporting layer is created wherein dimensions and relationship hierarchies are created automatically. Further, a cube structure is created based on the custom measures present in the system.

At step 535, the application is generated after performing one of adhoc reporting layer creation and interface layer creation.

At step 555, the flowchart ends.

Advantageously, portable data analytics device simplifies the laborious coding required to create BI applications. Since the portable data analytics device automatically generates BI applications by dynamically integrating with existing OLTP and OLAP systems, the time taken to develop complex analytical applications can be reduced from six months to six weeks.

In the preceding specification, the present disclosure and its advantages have been described with reference to specific embodiments. However, it will be apparent to a person of ordinary skill in the art that various modifications and changes can be made, without departing from the scope of the present disclosure.

Accordingly, the specification and figures are to be regarded as illustrative examples of the present disclosure, rather than in restrictive sense. All such possible modifications are intended to be included within the scope of the present disclosure.

What is claimed is:

1. A portable device for automating data analytics, the portable device comprising:
a configurator module, wherein the configurator module when plugged into a client device enables a user of the client device to configure a plurality of parameters; and
a Rapid Operational Visibility (ROVi) engine for automating data analysis, wherein the ROVi engine performs one or more of:
automating data capture from a plurality of data sources based on configured parameters;
creating a data model automatically;
automating creation of interfaces;
automating generation of a semantic layer; and
enabling the user to create customized analytical reports.

2. The portable device as claimed in claim 1, wherein the plurality of parameters comprise at least one of business rules, user interface (UI) screens, interface to external data sources, and definition of key performance indicators.

3. The portable device as claimed in claim 1, wherein the ROVi engine creates an optimized data model for reporting.

4. The portable device as claimed in claim 1, wherein the ROVi engine comprises a user interface (UI) generator for automating creation of UI screens, wherein the UI screens enable the user to enter data.

5. The portable device as claimed in claim 1, wherein the ROVi engine comprises an interface generator to automatically integrate data from external sources.

6. The portable device as claimed in claim 1, wherein the semantic layer enables multi-dimensional data analysis.

7. The portable device as claimed in claim 1, wherein the semantic layer enables creation of customized analytical reports.

8. A system for automating data analysis, the system comprising:
a configurator module for enabling a user to configure parameters, wherein the parameters comprises at least one of business rules, user interface (UI) screens, interface to external data sources, and definition of key performance indicators; and
a Rapid Operational Visibility (ROVi) engine for automating data analysis, the ROVi engine comprising:
a data modeller for performing one of
capturing data automatically based on configured parameters;
and
creating an optimized data model for reporting;
a master data management (MDM) generator to ensure quality of data;
a user interface (UI) generator for automating generation of UI screens;
an interface generator to automatically integrate data from external sources; and
a semantic layer generator for multi-dimensional data analysis and creation of custom reports.

9. The system of claim 8, wherein the UI generator binds data from the UI screens to a data model.

10. The system of claim 9, wherein the UI screens enable the user to enter data.

11. The system of claim 8, wherein the interface generator binds data from the external sources to a data model.

12. The system of claim 8, wherein the MDM generator comprises:
an MDM procedure generator to generate procedures that allow at least one of
creation of master data,
updation of the master data, and
disabling the master data;
a data quality monitoring module for enforcing data quality; and
a web service generator for creating web services, wherein the web services allows external applications to access the master data.

13. A computer-implemented architecture for automating data analysis, the computer-implemented architecture comprising:
a processor coupled to, at least one storage system, at least one input device, and at least one output device to receive data and instructions, the processor programmable to operate:
a configurator module for enabling a user to configure parameters,
wherein the parameters comprises at least one of business rules, user interface (UI) screens, interface to external data sources, and definition of key performance indicators;
a Rapid Operational Visibility (ROVi) engine for automating data analysis, the ROVI engine comprising:
a data modeller for performing one of
capturing data automatically based on configured parameters;
and
creating an optimized data model for reporting;
a master data management (MDM) generator to ensure quality of data;
a user interface (UI) generator for automating generation of UI screens;
an interface generator to automatically integrate data from external sources; and
a semantic layer generator for multi-dimensional data analysis and creation of customized analytical reports.

14. The computer-implemented architecture of claim 13, wherein the UI generator binds data from the UI screens to a data model.

15. The computer-implemented architecture of claim 14, wherein the UI screens enable the user to enter data.

16. The computer-implemented architecture of claim 13, wherein the interface generator binds data from the external sources to a data model.

17. The computer-implemented architecture of claim 13, wherein the MDM generator comprises:
an MDM procedure generator to generate procedure that allow at least one of
creation of master data,
updation of the master data, and
disabling the master data;
a data quality monitoring module for enforcing data quality; and
a web service generator for creating web services, wherein the web services allows external applications to access the master data.
